(19) United States
(12) Patent Application Publication
(10) Pub. No.: US 2006/0056598 A1
(43) Pub. Date: Mar. 16, 2006

(54) Detection of TTY's using programmable filters

(75) Inventors: Jeffrey Lewis Brandt, Cedar Park, TX (US); Lawrence Carey Howell JR., Austin, TX (US)

Correspondence Address: BRINKS HOFER GILSON & LIONE, P.O. BOX 10395, CHICAGO, IL, 60610, US

(73) Assignee: SBC Knowledge Ventures, L.P.

(21) Appl. No.: 10/940,115

(22) Filed: Sep. 14, 2004

(51) Int. Cl. H04M 11/00

(52) U.S. Cl. 379/52

(57) ABSTRACT

A method and system are disclosed for detecting a call made to the system, answering the call, and optionally, plays an announcement. The caller responds by, pressing a DTMF key or keys, sending TTY tones, speaking a response or doing nothing. A user who presses a TTY key or keys, or a TTY device that sends an auto-ID string generates TTY tones and the system detects TTY tones of at least about 30 milliseconds and greater. The system connects the call to another person, platform or portion of the service logic specifically designed for TTY calls.

### FIELD OF THE INVENTION

The invention relates to a system and method for detecting text telephone (TTY) signals using programmable filters.

### BACKGROUND

Section 255 of the Telecommunications Act requires that TTY users have access to automated telephony services such as voice mail. It is, therefore, desirable for providers of telephony services which require responses from a user to be able to determine whether a user is responding by using signals from a telecommunication device for the deaf (TDD), or a text telephone (TTY), hereinafter both referred to as TTY devices. Additionally, it is desirable to be able to detect the use of TTY devices by the same equipment that detects the use of dual tone multi-frequency (DTMF) signals and spoken commands. Without the ability to detect TTY device signals there are few solutions, all of which are less desirable than the present invention, to comply with the requirements of section 225. For example, one solution to comply with section 255 is maintaining and publishing two separate telephone lines, one for TTY and one for DTMF and voice commands. Another solution entails maintaining and publishing only a single telephone line but transmitting and receiving all prompts in TTY, DTMF and voice commands.

### BRIEF SUMMARY

The present invention can detect and route TTY calls, DTMF calls and voice command calls, all of which can come in at different times on a common line. If the invention determines a TTY device is being used on the line for a particular call, the call is routed to the appropriate destination, such as a live operator with a TTY device or an automated system specifically designed to work with TTY devices.

The invention uses programmable filters in a voice board to detect calls made by users of TTY devices in an automated communications system. The invention includes answering an incoming call, detecting a TTY signal of about 44 milliseconds duration, and connecting the call to a person, platform or portion of a service logic specifically designed for TTY calls.

### BRIEF DESCRIPTION OF THE DRAWINGS

FIG. 1 is a diagram for a system for detection of TTY signals.

FIG. 2 is a flow chart for detection of TTY signals in the system.

FIG. 3 is a flow chart for detection of TTY signals in the system.

FIG. 4 is a flow chart for directing calls based on detection of signals in a system.

### DETAILED DESCRIPTION

Current TTY tone detectors exist and are designed to detect and decode TTY tones in a message into a readable text format. The system 100, however, allows a standard voice processing board, such as a Dialogic Corporation Voice Board, to detect the presence of TTY signals without decoding what the TTY signals mean, without the need for a separate TTY tone detector.

Additionally, the system 100 can detect the presence of TTY signals without sending TTY signals out over the line. This is advantageous in that hearing callers would not hear what they think is noise on the line, but in fact are TTY signals. Instead, a voice announcement is provided with the expectation that a TTY calling party will respond with a TTY signal. Many TTY users have been taught to press a key, such as the space bar, to send out TTY signals when making a call to signal a hearing party to connect a TTY to the line to continue the call. Such practice is common and is widely used by public service agencies including police, fire and ambulance services to allow a hearing dispatcher to communicate with a hearing impaired citizen using a TTY device. Therefore, by playing a recording, a response from a TTY user is elicited and the detection of the TTY signals allows for an automated response.

Furthermore, a single voice board may be used to detect TTY, DTMF and voice signals and route the calls to the appropriate destinations. Thereby a cost savings can be realized since current voice processing boards can have their software modified to allow them to detect TTY tones, thereby allowing companies to comply with the requirements of section 255 without making expensive hardware changes to their telephone systems.

The system 100 detects a call being made to the system and answers the call, and optionally, plays an announcement. The caller responds such as by, pressing a DTMF key or keys, sending TTY tones, speaking a response or doing nothing. A user who presses a DTMF key or keys will generate detectable DTMF tones and the system will branch that call to the appropriate person, platform or portion of the service logic that handles DTMF calls. A user who presses a TTY key or keys, or a TTY device that sends an auto-ID string will generate TTY tones and the system will connect the call to another person, platform or portion of the service logic specifically designed for TTY calls. A user who speaks will generate detectable speech signals and the system will connect the call to another person, platform or portion of the service logic specifically designed for voice recognition calls. Finally, in the event the caller does nothing, the system times out, and the system will connect the call to another person, platform or portion of the service logic specifically designed for handling calls from callers who are unwilling or unable to use the automated service or the call may be terminated.

TTY tones include single tones of 1800 hertz (“0 bit”) and 1400 hertz (“1 bit”) with a 22 millisecond duration. Characters are formed by combinations of these frequencies using the Baudot code. The Baudot code uses a sequence of five data pulses to represent upper case alphabetic characters, numeric characters, and the common punctuation marks, and start and stop pulses to set off the data pulses.

Because of the failure of the manufacturers of TTY terminals to agree on a standard specification, there is none. There is, however, a draft to a standard. That standard, draft 9 (June, 1986, PN-1663), was placed in the public domain by the Electronic Industries Association Engineering Committee TR41 in 1981. The implementation of conversions from ASCII to TTY and vice-versa follows that standard. TTY uses 5-level Baudot Code at a nominal speed of 45.45 baud (1000/22, to be precise), half-duplex transmission. For a specification of character formats see page 41 of PN-1663.

Each character to be transmitted includes 7, 7.5 or 8 bits, including one start bit, five data bits and 1, 1.5 or 2 stop bits. The bit duration, according to the specification, is 22.00 milliseconds plus or minus 0.40 ms. The start bit is a binary zero (0) and is generated by a 22 millisecond 1800 hertz tone. The stop bit is a binary one (1) and is generated by a 33 millisecond 1400 hertz tone.

Commonly used voice processing boards, such as the Dialogic Corporation voice board, cannot detect occurrences of the same tone without a pause in between. Additionally, commonly used voice processing boards cannot detect occurrences of less than 30 milliseconds. Therefore, such a board cannot be used to decode Baudot codes. However, such a board can be programmed to detect TTY tones if a sufficient number of identical bits are presented as part of a string. Thereby, the presence of a single tone may exceed the detection threshold of 30 milliseconds.

For example, the Baudot code for the letter “O” is 01100011, which includes the start bit and stop bits. This would be detected as 101 since the first zero (0), or start bit, is too short to be detected and is thus ignored, the following two ones (1) are detected as a single 44 millisecond one (1), the following three zeros (0) are detected as a single 66 millisecond zero (0), and the last two ones (1), the stop bits, would be detected as a single 33 millisecond one (1). The board would detect the sequence 101, which however, is not a proper Baudot code for a TTY device. Detecting 101, however, is enough information to determine that a TTY character was sent over the telephone line even though it cannot be determined which character was sent.

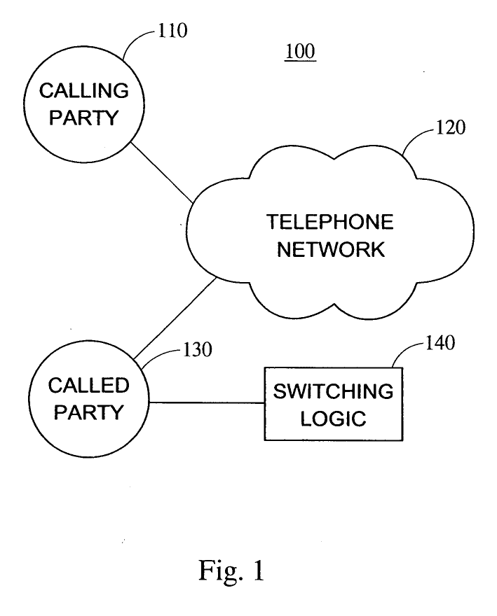

Turning now to FIG. 1, a diagram of an automated system for detection of TTY signals 100 is shown. The system includes a calling party 110, the telephone network 120, a called party 130 and switching logic 140. The automated system operates by the calling party 110 placing a call on the telephone network 120. The telephone network 120 routes the call to the called party 130. The called party 130 answers the call and switching logic 140, such as an application, determines, based on the response of the calling party 110, how the call should be routed.

The switching logic 140, or application, can include a computer program, for example, that is performed with software, hardware or firmware, or a combination thereof. The application can be stored on a computer usable medium having a computer readable code. The computer usable medium can include one or more mediums. The application can reside at, for example, the originating central office or other part of a communication system.

If the switching logic 140 determines that the calling party 110 has failed to respond, and thus, a time out condition exists, the switching logic 140 provides service for a rotary telephone caller and continues service by routing the call to the appropriate destination. If switching logic 140 detects TTY signals, the switching logic 140 provides service for a TTY device and continues service by routing the call to the appropriate destination. If the switching logic 140 detects DTMF, or Touch Tone, signals, the switching logic 140 provides service for DTMF, or Touch Tone, signals and continues service by routing the call to the appropriate destination. If the switching logic 140 detects voice signals, switching logic 140 provides service for voice signals and continues service by routing the call to the appropriate destination.

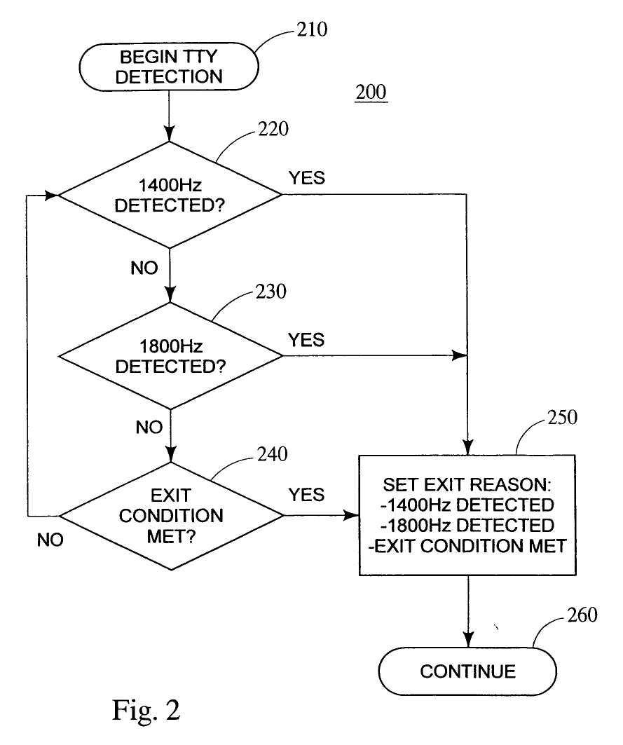

Turning now to FIG. 2, a flow chart for detection of TTY signals 200, such as in the system 100, is shown. A call is received and answered by the called party 130 and the switching logic 140 checks the line for TTY signals 210. The switching logic 140 then determines whether a 1400 Hertz signal, plus or minus 40 Hertz, is detected 220. In order for the TTY signal to be detected at block 220 the signal can be present for preferably about 44 milliseconds and more preferably about 33 milliseconds but at least 30 milliseconds.

If a 1400 Hertz signal is detected 220 the system proceeds to block 250 and the exit reason is set as detection of a 1400 Hertz signal and the call is then processed accordingly 260. However, if no 1400 Hertz signal is detected at block 220 the system determines whether a 1800 Hertz signal, plus or minus 40 hertz, is detected 230. In order for the TTY signal to be detected at block 230 the signal can be present for preferably about 44 milliseconds and more preferably about 33 milliseconds but at least 30 milliseconds.

If a 1800 Hertz signal is detected 230 the system proceeds to block 250 and the exit reason is set as detection of a 1800 Hertz signal and the call is then processed accordingly 260. However, if no 1800 Hertz signal is detected at block 230 the switching logic 140 determines whether an exit condition has been met 240. Examples of exit conditions include detection of DTMF tones, a voice signal, or a time out condition.

If the exit condition has not been met 240 the switching logic 140 rechecks whether a 1400 Hertz signal is detected 220. However, if an exit condition has been met 240 the switching logic 140 proceeds to block 250 and the exit reason is set as exit condition met and the call is then processed accordingly 260.

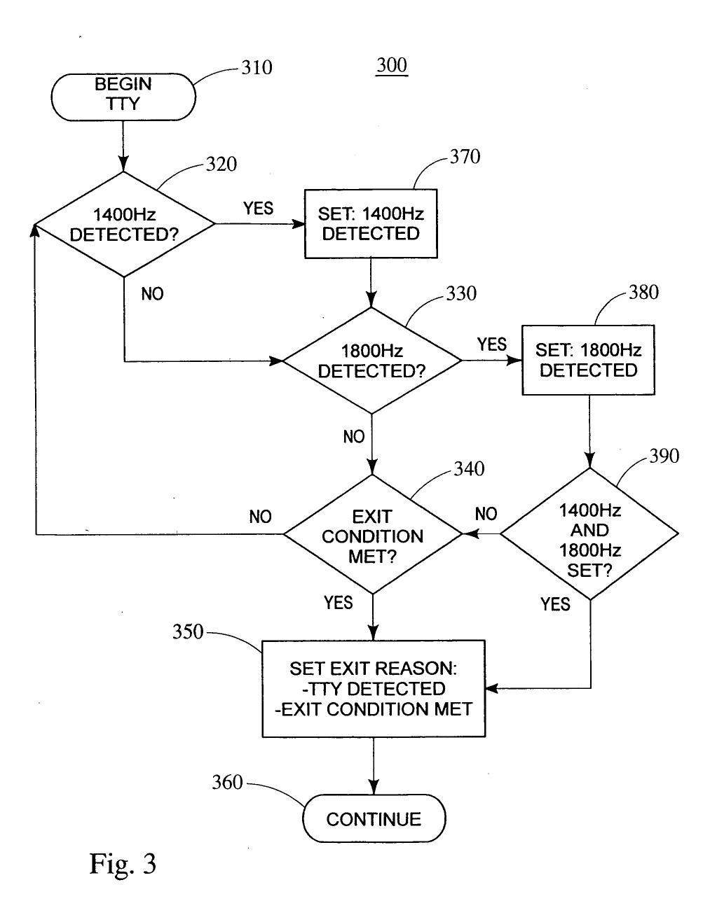

Turning now to FIG. 3, a flow chart for detection of TTY signals 300 in a communication system is shown. A call is received and answered by the system and the system checks the line for TTY signals 310. The system then determines whether a 1400 Hertz signal, plus or minus 40 Hertz, is detected 320. In order for the TTY signal to be detected at block 320 the signal can be present for preferably about 44 milliseconds and more preferably about 33 milliseconds but at least 30 milliseconds.

If no 1400 Hertz signal is detected at block 320 the switching logic 140 determines whether a 1800 Hertz signal, plus or minus 40 hertz, is detected 330. However, if a 1400 Hertz signal is detected 320 the system sets a flag to indicate that a 1400 Hertz signal has been detected 370 and the system determines whether a 1800 Hertz signal, plus or minus 40 Hertz, is detected 330. In order for the TTY signal to be detected at block 330 the signal can be present for preferably about 44 milliseconds and more preferably about 33 milliseconds but at least 30 milliseconds.

If an 1800 Hertz signal is detected at block 330 the system sets a flag to indicate that an 1800 Hertz signal has been detected 380. The system then determines whether both the 1400 Hertz and 1800 Hertz flags have been set 390. If both the 1400 Hertz and 1800 Hertz flags have been set 390 the exit reason is set as detection of a TTY device and the call is then processed accordingly 360. Requiring detection of, and setting a flag for, both the 1400 Hertz and 1800 Hertz signals decreases the chance that a non-TTY response is detected as a TTY response.

However, if no 1800 Hertz signal is detected at block 330 the switching logic 140 determines whether an exit condition has been met 340. Examples of exit conditions include detection of DTMF tones, a voice signal, or a time out condition. If the exit condition has not been met 340 the system rechecks whether a 1400 Hertz signal is detected 320. However, if an exit condition has been met 340 the system proceeds to block 350 and the exit reason is set as exit condition met and the call is then processed accordingly 360.

Additionally, if both the 1400 Hertz and 1800 Hertz flags have not been set 390 the system checks to see if an exit condition has been met 350. If the exit condition has not been met 340 the system rechecks whether a 1400 Hertz signal is detected 320. However, if an exit condition has been met 340 the system proceeds to block 350 and the exit reason is set as exit condition met and the call is then processed accordingly 360.

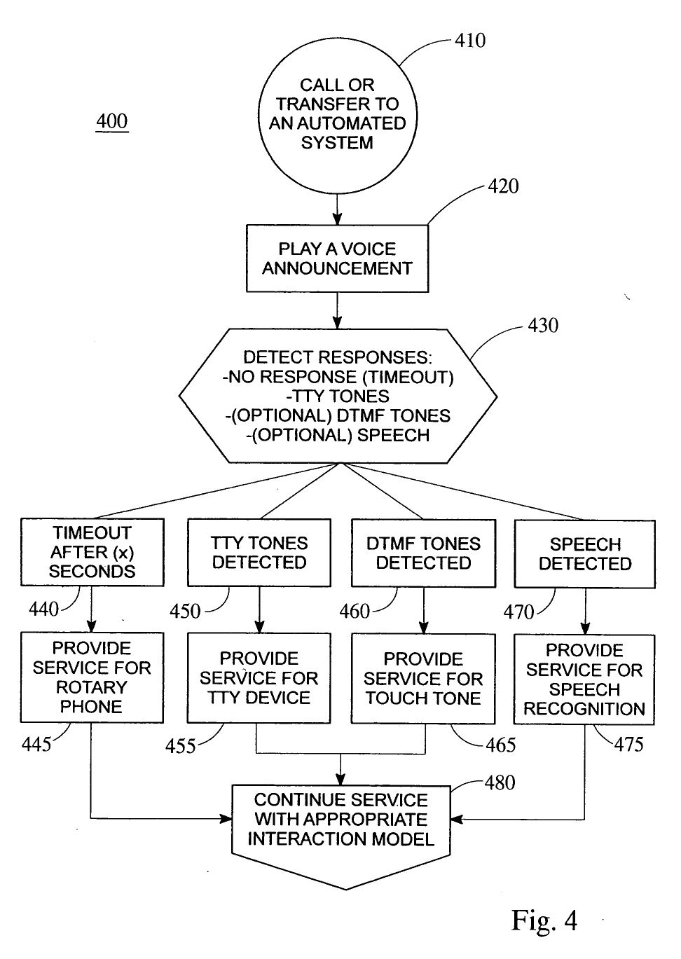

Turning now to FIG. 4, a flow chart for directing calls based on detection of signals in an automated communication system 400 is shown. A call is received at, or transferred to, the automated communication system 410. The automated communication system 400 plays a voice announcement 420. In one embodiment, the announcement 420 may not transmit any TTY signals. In another embodiment, the announcement 420 may also transmit TTY signals. The automated communication system 400 determines whether the caller fails to respond, responds with TTY signals, responds with DTMF tones, or responds with a speech signal 430.

If the automated communication system 400 determines that a caller has failed to respond, and thus, a time out condition exists 440, the automated system 400 provides service for a rotary telephone caller 445 and continues service by routing the call to the appropriate destination 480.

If the automated communication system 400 detects TTY signals 450, the automated system 400 provides service for a TTY device 455 and continues service by routing the call to the appropriate destination 480.

If the automated communication system 400 detects DTMF, or Touch Tone, signals 460, the automated system 400 provides service for DTMF, or Touch Tone, signals 465 and continues service by routing the call to the appropriate destination 480.

If the automated communication system 400 detects voice signals 470, the automated system 400 provides service for voice signals 475 and continues service by routing the call to the appropriate destination 480.

It is therefore intended that the foregoing detailed description be regarded as illustrative rather than limiting, and that it be understood that it is the following claims, including all equivalents, that are intended to define the spirit and scope of this invention.

We claim:

1. A method for using programmable filters in a voice board to detect calls made by users of TTY devices in an automated communications system, the method comprising:
answering an incoming call;
detecting a TTY signal of about 44 milliseconds duration; and
connecting the call to a person, platform or portion of a service logic specifically designed for TTY calls.

2. The method of claim 1 wherein the TTY signal has a duration of about 33 milliseconds.

3. The method of claim 2 wherein the TTY signal has a duration of at least 30 milliseconds.

4. The method of claim 1 wherein the TTY signal has a frequency of approximately 1800 Hertz.

5. The method of claim 1 wherein the TTY signal has a frequency of approximately 1400 Hertz.

6. The method of claim 1 further comprising playing an announcement after answering the call.

7. The method of claim 1 further comprising playing an announcement that does not contain TTY signals after answering the call.

8. A system using programmable filters in a voice board to detect calls made by users of TTY devices in an automated communications system, the system comprising:
an application to answer an incoming call;
an application to detect a TTY signal of about 44 milliseconds duration; and
an application to connect the call to a person, platform or portion of a service logic specifically designed for TTY calls.

9. The system of claim 8 wherein the TTY signal has a duration of about 33 milliseconds.

10. The system of claim 9 wherein the TTY signal has a duration of at least 30 milliseconds.

11. The system of claim 8 wherein the TTY signal has a frequency of approximately 1800 Hertz.

12. The system of claim 8 wherein the TTY signal has a frequency of approximately 1400 Hertz.

13. The system of claim 8 further comprising playing an announcement after answering the call.

14. The system of claim 8 further comprising playing an announcement that does not contain TTY signals after answering the call.

15. A method of using programmable filters in a voice board to detect calls made by users of TTY devices in an automated communications system, the method comprising:
receiving a call;
playing a voice announcement;
determining whether a caller responds with TTY signals of about 44 milliseconds duration; and
continuing service by routing the call to an appropriate destination.

16. The method of claim 15 wherein the TTY signal has a duration of about 33 milliseconds.

17. The method of claim 16 wherein the TTY signal has a duration of at least 30 milliseconds.

18. The method of claim 15 wherein the TTY signal has a frequency of approximately 1800 Hertz.

19. The method of claim 15 wherein the TTY signal has a frequency of approximately 1400 Hertz.

20. The method of claim 15 wherein voice announcement does not include any TTY signals.
